(19) United States
(12) Patent Application Publication
(10) Pub. No.: US 2025/0317822 A1
(43) Pub. Date: Oct. 9, 2025

(54) INTER-NETWORK ENTITY LOWER LAYER TRIGGERED MOBILITY

(71) Applicant: QUALCOMM Incorporated, San Diego, CA (US)

(72) Inventors: Naeem AKL, San Jose, CA (US); Jelena DAMNJANOVIC, Del Mar, CA (US); Ozcan OZTURK, San Diego, CA (US)

(21) Appl. No.: 19/092,150

(22) Filed: Mar. 27, 2025

Related U.S. Application Data
(60) Provisional application No. 63/574,470, filed on Apr. 4, 2024.

(51) Int. Cl. H04W 36/08; H04W 36/00

(52) U.S. Cl. CPC H04W 36/08; H04W 36/0058

(57) ABSTRACT

Certain aspects of the present disclosure provide techniques for inter-network entity lower layer triggered mobility (LTM). An example method for wireless communications includes obtaining, from a first network entity, a configuration for LTM among multiples cells served among at least the first network entity and a second network entity, wherein the configuration includes a first set of configurations associated with a first cell and a second set of configurations associated with a second cell, wherein the cells includes the first cell and the second cell; obtaining a first indication that the first set of configurations is associated with the first network entity and that the second set of configurations is associated with the second network entity; and communicating with the first network entity or the second network entity via the first cell or the second cell based on the first set of configurations or the second set of configurations.

### Cross-Reference to Related Application(s)

The present Application for Patent claims benefit of and priority to U.S. Provisional Application No. 63/574,470, filed Apr. 4, 2024, which is hereby expressly incorporated by reference herein in its entirety.

### INTRODUCTION

### Field of the Disclosure

Aspects of the present disclosure relate to wireless communications, and more particularly, to techniques for mobility management.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes obtaining, from a first network entity, at least one configuration for lower layer triggered mobility (LTM) among a plurality of cells served among at least the first network entity and a second network entity, wherein the at least one configuration includes a first set of configurations associated with a first cell and a second set of configurations associated with a second cell, wherein the plurality of cells includes the first cell and the second cell; obtaining a first indication that the first set of configurations is associated with the first network entity and that the second set of configurations is associated with the second network entity; and communicating with one or more of the first network entity or the second network entity via one or more of the first cell or the second cell based at least in part on one or more of the first set of configurations or the second set of configurations.

Another aspect provides a method for wireless communications by a first network entity. The method includes sending at least one configuration for LTM among a plurality of cells served among at least the first network entity and a second network entity, wherein the at least one configuration includes a first set of configurations associated with a first cell and a second set of configurations associated with a second cell, wherein the plurality of cells includes the first cell and the second cell; sending a first indication that the first set of configurations is associated with the first network entity and that the second set of configurations is associated with the second network entity; and communicating with a UE via the first cell based at least in part on the first set of configurations.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIGS. 5A and 5B depict example protocol stacks for exchanging information between a UE and a network entity.

FIG. 6 depicts an example of UE mobility in a wireless communications network.

FIG. 7 depicts an example scheme for inter-network entity lower layer triggered mobility (LTM) configuration(s).

FIG. 8 depicts a process flow for signaling for inter-network entity LTM.

FIG. 9 depicts a method for wireless communications.

FIG. 10 depicts another method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for inter-network entity lower layer triggered mobility (LTM).

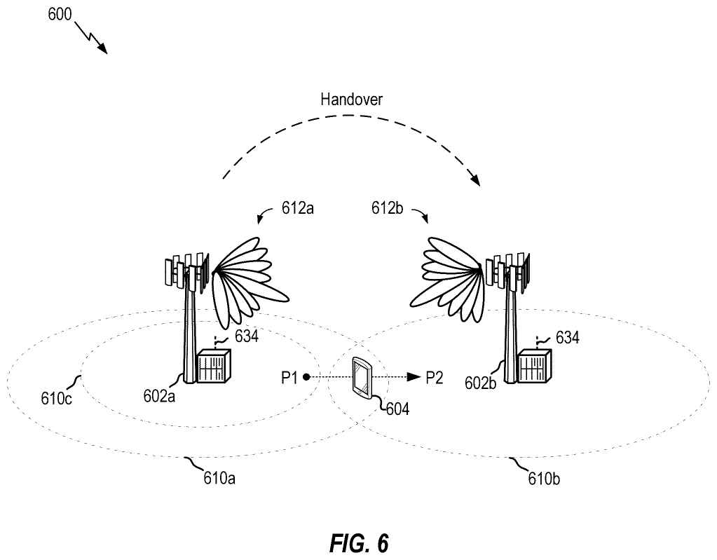

Mobility management is a scheme employed to ensure service-continuity of a user equipment (UE) through handovers and/or beam switching during UE mobility, for example, as the UE moves across different coverage areas of a radio access network (RAN). During a handover, a source network entity (e.g., a base station) transfers a connection with a UE to a target network entity, which may be or include a neighboring network entity, for example, as further described herein with respect to FIG. 6. A neighboring network entity may communicate via candidate cell(s) and/or beam(s) having a coverage area adjacent to or overlapping with the coverage area of the source network entity. As the coverage area of a single network entity decreases, such as for high-frequency communications (e.g., millimeter-wave (mmWave) communications), the frequency for a UE to handover between network entities becomes high, especially for a high-mobility UE (e.g., a UE traveling in a vehicle). In addition, for applications (e.g., extended reality and/or cloud gaming) characterized with stringent performance specifications (e.g., quality of service (QoS) parameters such as reliability, latency, etc.), the quality of experience may be sensitive to the handover performance, such as unsuccessful handovers. An unsuccessful handover can cause packet losses and/or extra delay during the mobility period, which can cause QoS specifications to not be met for packet-drop-intolerant and low-latency applications.

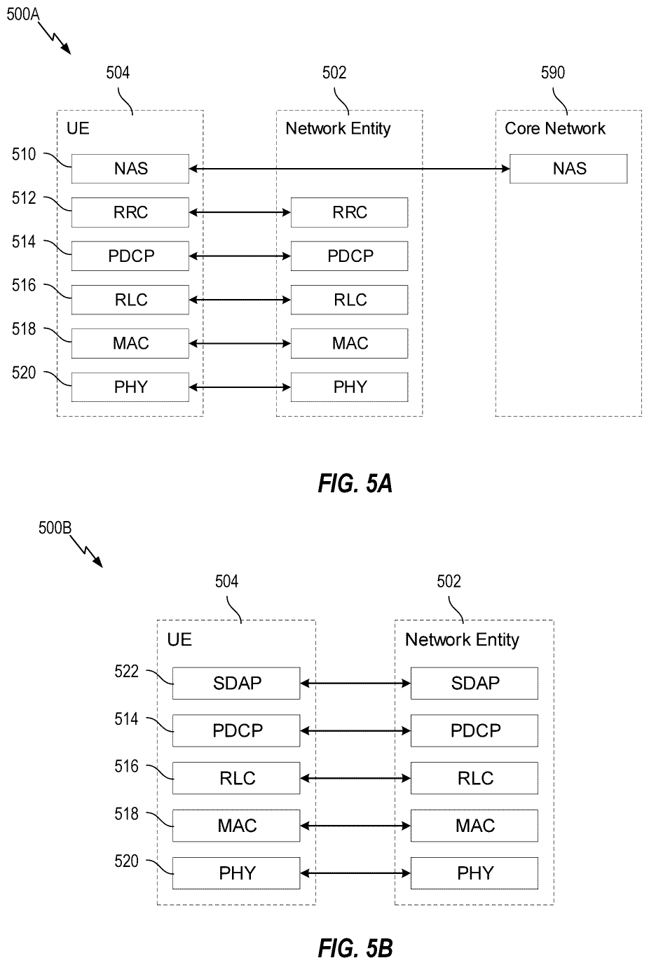

LTM may refer to a specific type of handover procedure where a UE is configured, such as via Layer-3 signaling, with multiple candidate configurations for communications via candidate cells, and a network entity changes a serving cell of a UE by a cell switch command, such as signaled via Layer-1 signaling and/or Layer-2 signaling. The cell switch command indicates a candidate configuration for communications via a candidate cell. Then, the UE switches to the candidate configuration for communications via the candidate cell according to the cell switch command. Layer-1, Layer-2, and Layer-3 may refer to certain layers in a control plane protocol stack, for example, as further described herein with respect to FIGS. 5A and 5B. The LTM procedure can be used to reduce the mobility latency, channel usage, and interruption time during a handover, for example, due to the UE being configured with multiple configurations for candidate cells.

Technical problems for mobility management may include, for example, providing effective procedures for inter-network entity LTM. Certain wireless communications systems (e.g., 5G NR systems) may only support LTM for cell changes among candidate cells served at or by the same network entity (e.g., intra-distributed unit (DU) and/or intra-centralized unit (CU) cell switch). For example, the UE may be configured with LTM configurations for candidate cells served by the same CU and/or DU, and the LTM cell switch command may indicate a serving cell change among the candidates served by the same DU and/or CU. However, certain wireless communications systems (e.g., 5G NR systems) may not have established procedures for inter-network entity LTM (e.g., inter-CU and/or inter-base station). Thus, for an inter-network entity handover, a non-trivial amount of time and/or communication resources may be used to transfer the RRC configuration for the target network entity from the target network entity to the source network entity and then from the source network entity to the UE during a handover procedure.

Aspects described herein may overcome the aforementioned technical problem(s), such as by providing certain techniques for inter-network entity LTM. A UE may obtain one or more configurations for inter-network entity LTM among a plurality of cells served among multiple network entities (e.g., CUs and/or base stations). In certain aspects, the UE may obtain, from a single network entity, at least one configuration that indicates or includes cell-specific configuration(s) associated with each of the cells served by the multiple network entities and network entity-specific configuration(s) common to the cells of the network entity for each of the multiple network entities. The cell-specific configuration(s) may include candidate configurations that enable a cell switch command to indicate a serving cell switch among candidate cells served by multiple network entities (e.g., CUs and/or base stations). As an example, the UE may obtain a reference configuration for each of the network entities and cell-specific parameter(s) for each of the cells. The reference configuration and the cell-specific parameter(s) may define a set of parameters for a specific cell. In certain aspects, the UE may obtain an indication of an identifier for at least one of the network entity and which cell-specific configuration(s) are associated with that network entity.

Certain techniques for inter-network entity LTM described herein may provide various beneficial technical effects and/or advantages. The techniques for inter-network entity LTM may enable improved mobility operations, such as reduced latencies, packet losses, handover failures, and/or ping-ponging between network entities. The techniques for inter-network entity LTM may ensure service continuity for traffic communicated via cells served across a plurality of network entities. For example, the techniques for inter-network entity LTM may enable a UE to obtain, from a first network entity, a cell switch command to communicate via a cell served by a second network entity. Such cell switch may reduce reduced latencies, channel usage, and/or interruption time for an inter-network entity handover procedure.

The term “beam” may be used in the present disclosure in various contexts. Beam may be used to mean a set of gains and/or phases (e.g., precoding weights or co-phasing weights) applied to antenna elements in (or associated with) a wireless communication device for transmission or reception. The term “beam” may also refer to an antenna or radiation pattern of a signal transmitted while applying the gains and/or phases to the antenna elements. Other references to beam may include one or more properties or parameters associated with the antenna (or radiation) pattern, such as an angle of arrival (AoA), an angle of departure (AoD), a gain, a phase, a directivity, a beam width, a beam direction (with respect to a plane of reference) in terms of azimuth and/or elevation, a peak-to-side-lobe ratio, and/or an antenna (or precoding) port associated with the antenna (radiation) pattern. The term “beam” may also refer to an associated number and/or configuration of antenna elements (e.g., a uniform linear array, a uniform rectangular array, or other uniform array).

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

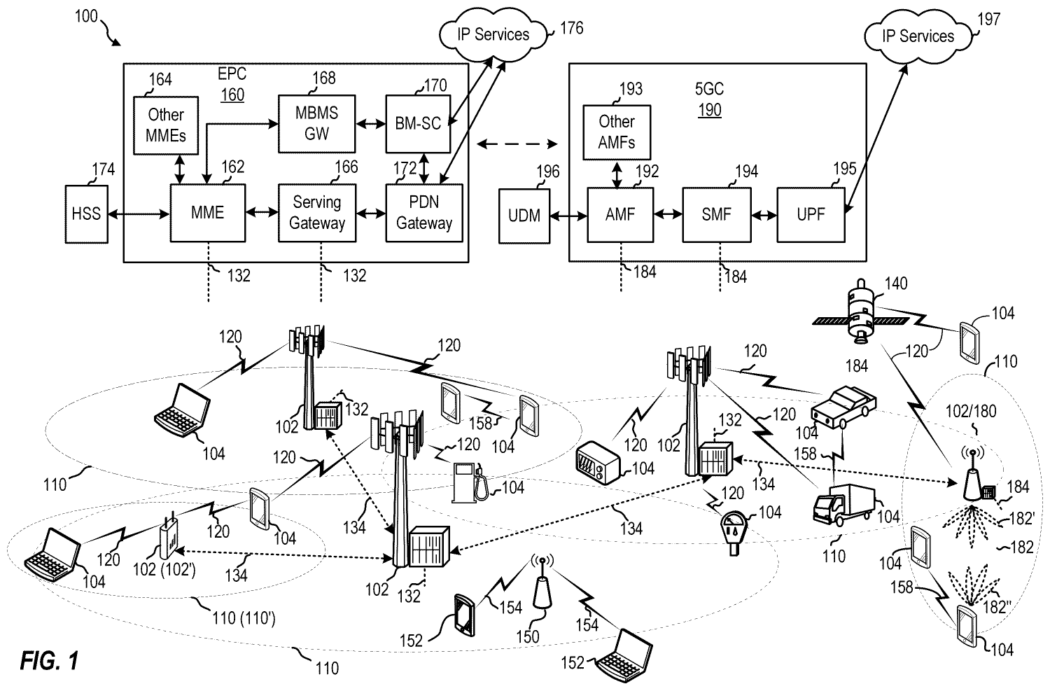

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

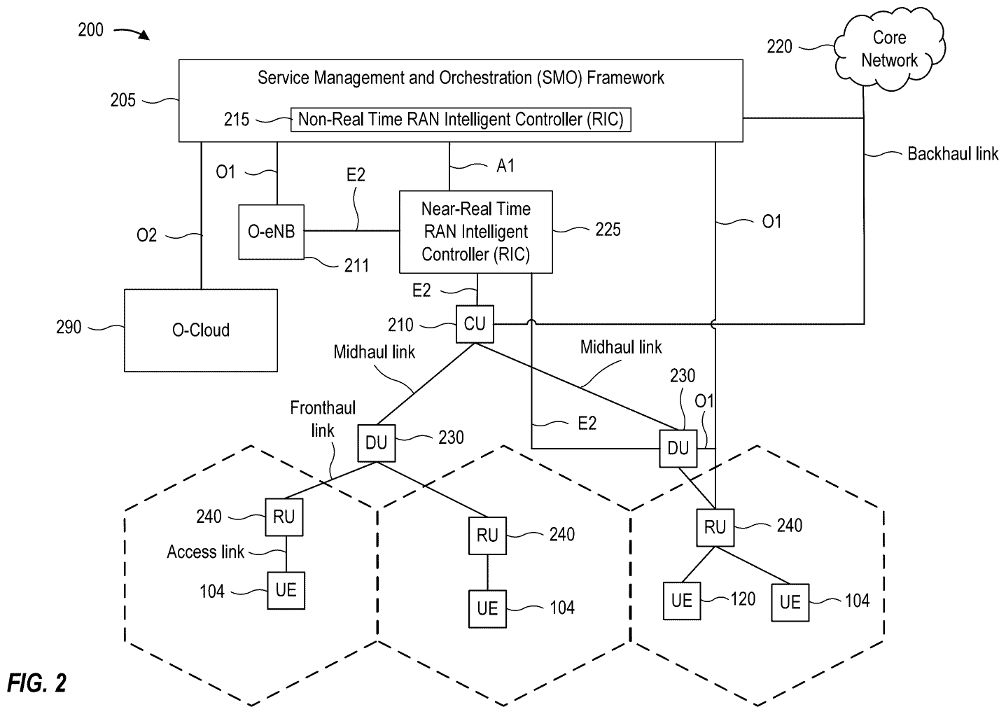

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

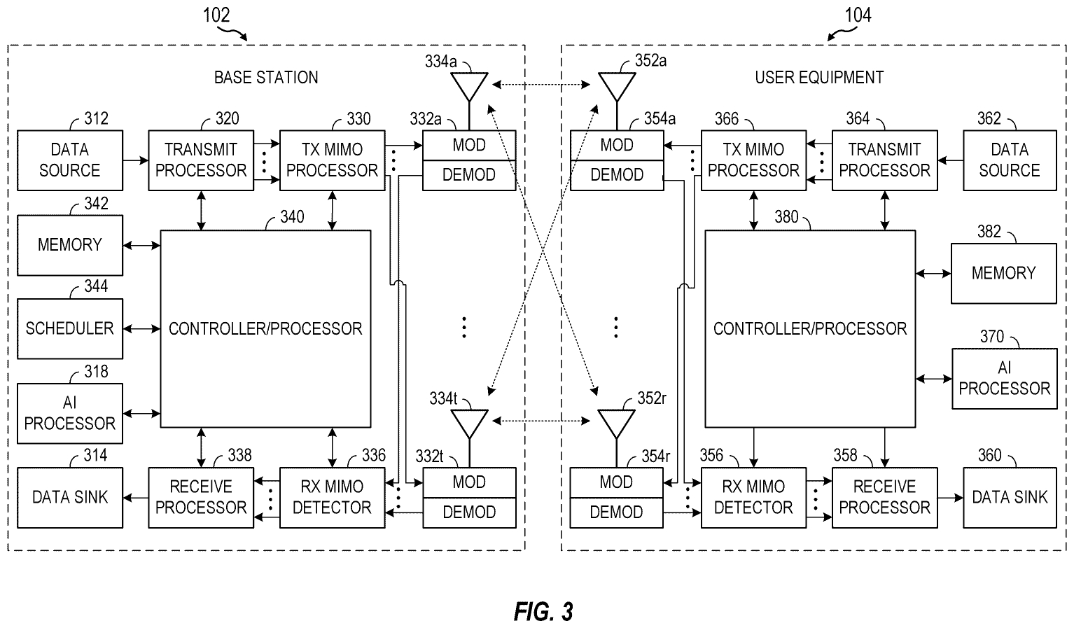

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

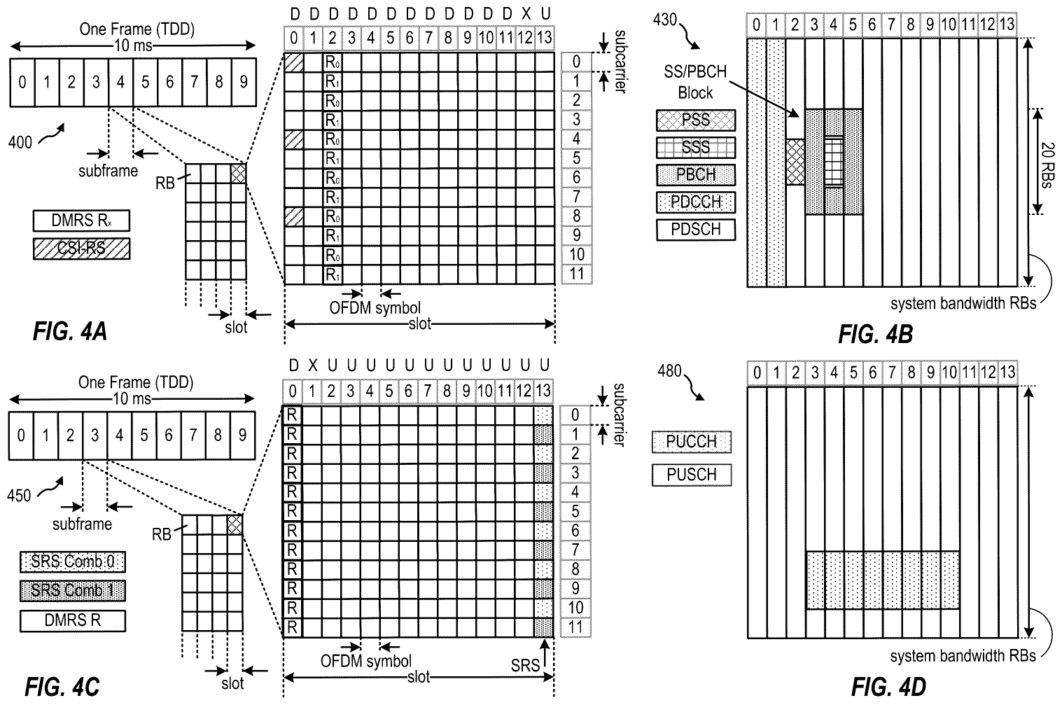

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Protocol Stacks

Certain wireless communications systems (e.g., 5G NR systems or any future wireless communications system) may employ protocol stack(s) to transfer information between a UE and a network entity, such as a base station and/or core network. As an example, 5G NR systems may use a user plan protocol stack and a control plane protocol stack to exchange application data and signaling messages. A user plane protocol stack may be responsible for transferring application data between the UE and an application server, and a control plane protocol stack may be responsible for transferring control signaling messages between the UE and a network entity.

FIG. 5A depicts an example control plane protocol stack 500A for exchanging control plane traffic (e.g., control signaling) between a user equipment (UE) 504 and a network entity 502, and between the UE 504 and a core network 590. In some aspects, the network entity 502 may be an example of the BS 102 depicted and described with respect to FIGS. 1 and 3 or a disaggregated base station depicted and described with respect to FIG. 2. Similarly, the UE 504 may be an example of UE 104 depicted and described with respect to FIGS. 1 and 3. The core network 590 may be an example of the 5GC network 190 and/or the core network 220 depicted and described with respect to FIGS. 1 and 2, respectively.

The control plane protocol stack 500A includes a non-access stratum (NAS) layer 510, a radio resource control (RRC) layer 512, a packet data convergence protocol (PDCP) layer 514, a radio link control (RLC) layer 516, a medium access control (MAC) layer 518, and a physical (PHY) layer 520. The NAS layer 510 carries mobility management and session management signaling between the UE 504 and the core network 590 (e.g., the AMF 192 and/or the SMF 194 of FIG. 1). The RRC layer 512 carries RRC signaling, for example, for paging, RRC connection establishment, RRC connection reconfiguration, and RRC connection release. The PDCP layer 514 provides ciphering and integrity protection for control plane signaling. The RLC layer 516 may segment a large packet into smaller packets and handles re-transmissions of RLC packets. The MAC layer 518 schedules transmissions between the UE 504 and the network entity 502 and controls the PHY layer. In the MAC layer 518, the UE 504 and the network entity 502 may communicate with each other by exchanging a MAC control element (MAC-CE). The PHY layer 520 handles transmission and reception across the air-interface between the UE 504 and the network entity 502. The PHY layer 520 provides certain error management tasks (e.g., cyclic redundancy check), certain digital signaling processing tasks (e.g., modulation and demodulation), and handles certain procedures for measurement and control (e.g., beam failure detection and/or radio link monitoring). The network entity 502 may send, to the UE 504, PHY layer signaling via downlink control information (DCI).

FIG. 5B depicts an example user plane protocol stack 500B for exchanging user plane traffic (e.g., application data) between the UE 504 and the network entity 502. The user plane protocol stack 500B includes a service data adaptation protocol (SDAP) layer 522, the PDCP layer 514, the RLC layer 516, the MAC layer 518, and the PHY layer 520. The SDAP layer 522 maps the quality of service (QoS) flow(s) used at the core network 590 (e.g., for a protocol data unit (PDU) session) to data radio bearer(s) used at the network entity 502 to communicate via an air-interface between the UE 504 and the network entity 502. In the user plane, the PDCP layer 514 provides packet header compression (e.g., transmission control protocol (TCP), user datagram protocol (UDP), and/or internet protocol (IP) header compression), ciphering, and integrity protection for user plane traffic.

The RRC layer 512 may form Layer-3 (L3) of the control plane protocol stack 500A. In the user plane, the SDAP layer 522, the PDCP layer 514, the RLC layer 516, and/or the MAC layer 518 may form Layer-2 (L2) of the user plane protocol stack 500B. In the control plane, the PDCP layer 514, the RLC layer 516, and/or the MAC layer 518 may form L2 of the control plane protocol stack 500A. The PHY layer 520 may form Layer-1 (L1) of the protocol stacks 500A, 500B. Layer-3 may include the highest or upper layers in the control plane protocol stack 500A; Layer-2 may include the intermediate layers in the control plane protocol stack 500A, where Layer-2 is arranged between Layer-3 and Layer-1; and Layer-1 may include the lowest layer in the control plane protocol stack 500A.

### Example Mobility Management

FIG. 6 depicts an example of UE mobility in a wireless communications network 600. In this example, the wireless communications network 600 may include a first network entity 602a having a first coverage area 610a and a second network entity 602b having a second coverage area 610b, which may overlap with the first coverage area 610a. The first network entity 602a may also have a third coverage area 610c. In certain aspects, the first coverage area 610a may form a first cell, the second coverage area 610b may form a second cell, and the third coverage area 610c may form a third cell. The first cell and third cell may form or be part of a first cell group, and the second cell may form or be part of a second cell group. The first network entity 602a may communicate via a first set of beams 612a, and the second network entity 602b may communicate via a second set of beams 612b.

Due to mobility (e.g., a UE 604 moving from the first coverage area 610a to the second coverage area 610b), the UE 604 may transition from communicating with the first network entity 602a via the first set of beams 612a to communicating with the second network entity 602b via the second set of beams 612b. As an example, the UE 604 may be located at a first position P1 in the first coverage area 610a and/or the third coverage area 610c at a first occasion, and then the UE 604 may move to a second position P2 in the second coverage area 610b at a second, later occasion.

In some cases, the UE 604 may send a measurement report to the first network entity 602a. For example, the first network entity 602a may configure the UE 604 to measure a set of neighboring cell(s) and/or beam(s) of one or more neighboring network entities (e.g., the second network entity 602b). In some cases, the UE 604 may identify neighboring cell(s) and/or beam(s) of a neighboring network entity, for example, via signaling transmitted by the neighboring network entity. The neighboring cell(s) and/or beam(s) may be or include candidate communication link(s) that the UE can handover or switch to from the cell(s) and/or beam(s) of the first network entity 602a. As an example, the neighboring cell(s) and/or beam(s) may include the second cell of the second coverage area 610b and/or the second set of beams 612b. The measurement report may indicate radio measurements (e.g., signal strengths) associated with the serving cell of the first network entity 602a and/or neighboring cell(s), such as the cell(s) of the second network entity 602b. In certain cases, the measurement report may indicate the signal strengths associated with certain beam(s) of the serving cell and the neighboring cell(s), such as the first set of beams 612a and/or the second set of beams 612b. Based on the measurement report (e.g., indicating a stronger signal strength associated with radio measurements for the second network entity 602b relative to the first network entity 602a), the first network entity 602a may determine to handover (HO) communications with the UE 604 to the second network entity 602b. The first network entity 602a may be in communication with the second network entity 602b via a backhaul link 634 (e.g., an F1, Xn, and/or NG interface) in order to exchange information for the handover.

In the context of a handover, the first network entity 602a may be referred to as a source network entity; and the second network entity 602b may be referred to as a target, candidate, neighbor, or neighboring network entity. During a handover, the source network entity transfers a connection with a UE to a target network entity. A candidate or neighboring network entity may be a possible target for a handover, and the candidate or neighboring network entity may communicate via candidate cell(s) and/or beam(s) having a coverage area adjacent to or overlapping with the coverage area of the source network entity.

In some cases, the handover may involve a CU/DU handover, such as inter-DU-intra-CU handover and/or inter-CU handover. For example, the handover may involve a handover from a source DU to a target or candidate DU in communication with a common CU (e.g., inter-DU-intra-CU handover). In some cases, the handover may involve a handover from a source CU to a target or candidate CU (e.g., inter-CU handover). Accordingly, the first network entity 602a and/or the second network entity 602b may be an example of an RU, DU, and/or CU.

Note that the handover illustrated in FIG. 6 is an example of a mobility operation, such as inter-network entity LTM. Aspects of the present disclosure described herein with respect to inter-network entity LTM may be applied to various types of UE mobility operations including, for example, an Xn based handover, an N2 based handover, conditional handover, beam selection, beam switch, (conditional) serving cell modification, (conditional) serving cell addition, (conditional) serving cell release, cell group modification, cell group addition, cell group release, dual active protocol stack (DAPS) handover, dual connectivity, or the like. A mobility operation or handover may be triggered, for example, due to radio conditions (e.g., in response to a measurement report), load balancing at a network entity, and/or a specific service (e.g., to ensure wireless communications performance satisfies certain QoS specification(s)).

### Aspects Related to Inter-Network Entity LTM

Aspects of the present disclosure provide certain techniques for inter-network entity LTM that enable reduced latencies, channel usage, and/or interruption times for handovers between network entities, such as an inter-CU handover.

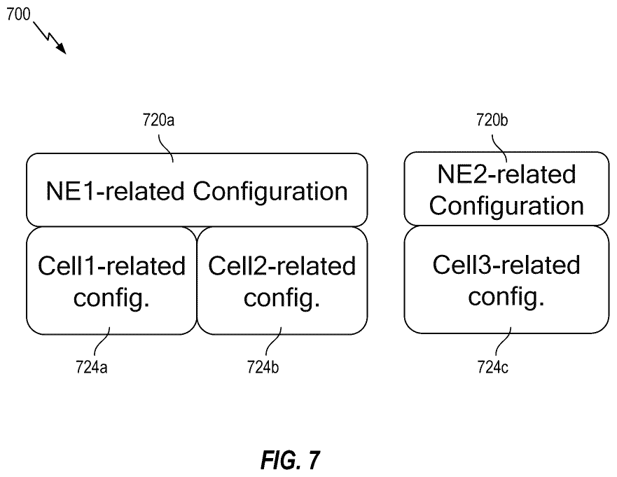

FIG. 7 depicts an example scheme 700 for inter-network entity LTM configuration(s). In this example, a UE obtains, from a first network entity (e.g., from a single network entity, such as the first network entity 602a), a first configuration 720a associated with the first network entity and a second configuration 720b associated with a second network entity (e.g., the second network entity 602b). In certain aspects, the first network entity may be or include a first CU, and the second network entity may be or include a second CU in communication with the first CU. The UE obtains, from the first network entity, cell-specific configurations 724a-c for a first cell, a second cell, and a third cell (e.g., the cells that form the coverage areas 610a-c) served among a plurality of network entities including the first network entity and the second network entity. The first network entity may serve or communicate via the first cell (e.g., the first coverage area 610a) and the second cell (e.g., the third coverage area 610c), and the second network entity may serve or communicate via the third cell (e.g., the second coverage area 610b).

The first configuration 720a may be an example of a network-entity specific configuration associated with the first network entity; and the second configuration 720b may be an example of a network-entity specific configuration associated with the second network entity. A network entity specific-configuration may refer to one or more configurations that include or indicate one or more parameters or settings used to communicate (for communication) with at least one network entity. In certain cases, the parameter(s) or settings (or at least a portion thereof) of the network entity-specific configuration may be dedicated to communications with a network entity and/or commonly applied for communications with multiple network entities. Note that the UE may obtain any number of network entity-specific configurations (e.g., the first configuration 720a and the second configuration 720b) and/or cell-specific configurations for inter-network entity LTM. In some cases, the first configuration 720a and the second configuration 720b may be integrated as or included in a single configuration for a plurality of network entities.

The UE may obtain an indication that the first configuration 720a and/or the cell-specific configurations 724a, 724b for the first cell and the second cell are associated with the first network entity, and that the second configuration 720b and/or the cell-specific configuration 724c for the third cell are associated with the second network entity. The association between a configuration for a network entity and/or a cell-specific configuration may be indicated via a network identifier or identity. As an example, the UE may obtain an indication of a first identifier for the first network entity and/or a second identifier for the second network entity via signaling from the first network entity and/or the second network entity (such as system information, synchronization signaling, or the like). In some cases, the UE may obtain an indication of the second identifier for the second network entity via signaling from the first network entity, or vice versa. The UE may obtain an indication that the first configuration 720a and/or the cell-specific configurations 724a, 724b for the first cell and the second cell are associated with the first identifier for the first network entity. The UE may obtain an indication that the second configuration 720b and/or the cell-specific configuration 724c for the third cell are associated with the second identifier for the second network entity. In some cases, the first configuration 720a and/or the second configuration 720b may have a configuration identifier or identify, which is representative of an identifier for a network entity or specific to the network entity.

The UE may obtain an identifier for a network entity that is serving (e.g., communicating with) or expected to be serving (e.g., communicating with) the UE, for example, via system information and/or a cell switch command. The UE may use the identifier for the network entity to determine which of the first configuration 720a or the second configuration 720b to use for communications with the respective network entity (e.g., the first network entity or the second network entity). For example, the UE may obtain certain signaling (e.g., system information and/or synchronization signaling) that indicates or includes the identifier for a network entity, and the UE may select the corresponding network entity-specific configuration and/or cell-specific configuration associated with the network entity that matches the identifier for the network entity. In some cases, an LTM cell switch command may indicate the target network entity for the cell switch via an identifier for the network entity. For example, the UE may obtain, from the first network entity, an LTM cell switch command that indicates to change the serving cell of the UE to the third cell and indicates the second identifier for the second network entity. The UE may switch to the cell-specific configuration 724c for the third cell and the second configuration 720b according to the LTM cell switch command, which indicates or includes the identifier for the third cell and/or the second identifier for the second network entity.

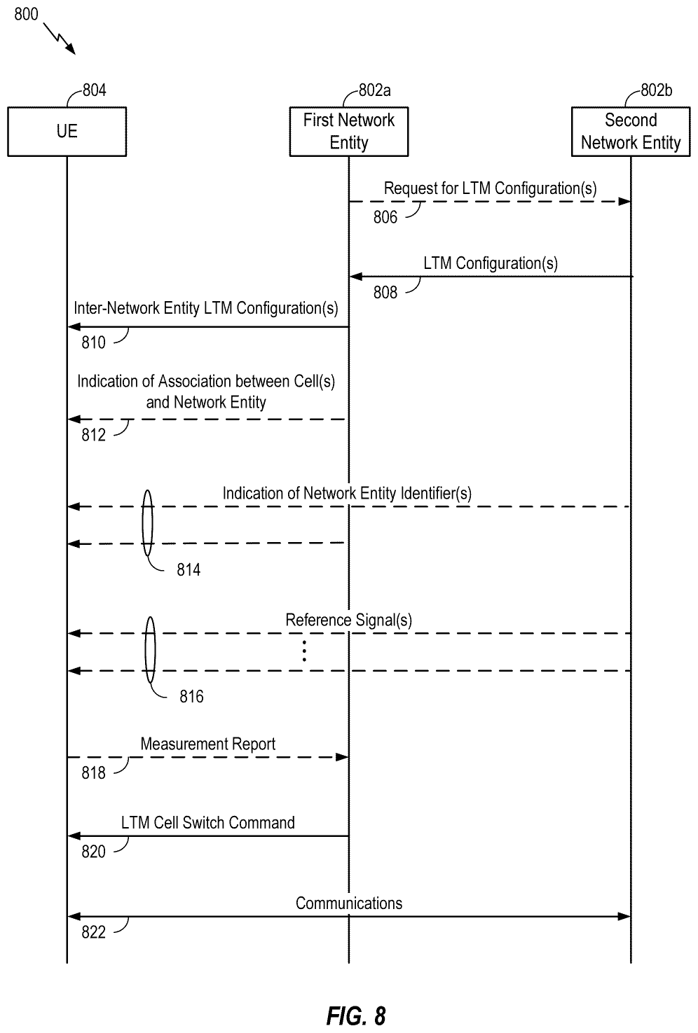

In certain aspects, the identifier for a network entity may be or include an identifier for a specific network entity, such as a gNB identity or identifier (e.g., with respect to a NR cell global identity or the like), a CU identity or identifier, and/or a list of DUs managed or controlled at or by a CU. In certain aspects, the identifier for a network entity may be or include one or more tracking areas associated with the network entity and/or cells served by or at the network entity. In certain aspects, the identifier for a network entity may be or include a list of cells (or corresponding cell identities) served by or at the network entity. For example, the first identifier may be or include a first list of cells including the first cell and the second cell, and the second identifier may be or include a second list of cells including the third cell. The identifier for a network entity may be communicated via RRC signaling, MAC signaling, DCI, and/or system information (e.g., a system information block (SIB)). In some cases, the identifier for a network entity may be communicated via an LTM cell switch command as further described herein with respect to FIG. 8.

Each of the first configuration 720a and the second configuration 720b may be or include a configuration specific to a particular network entity and/or cells served by or at the network entity. Each of the first configuration 720a and the second configuration 720b may indicate or include common parameter(s) or settings for communications with the respective network entity. For example, the first configuration 720a may indicate or include a common set of parameters used for communications via the first cell and the second cell of the first network entity, whereas the second configuration 720b may indicate or include a common set of parameters used for communications via the third cell of the second network entity. The common parameter(s) associated with a network entity and/or one or more cells served by or at the network entity may include, for example, a reference configuration for an RRC reconfiguration message, a CSI resource configuration, or the like.

Each of the cell-specific configurations 724a-c may be or include a candidate configuration for a candidate cell. Each of the cell-specific configurations 724a-c may indicate or include a set of configurations, a set of parameter(s), and/or or settings for communications via the respective cell. For example, the cell-specific configuration 724a for the first cell may indicate or include a set of parameters for communications via the first cell. The cell-specific configuration 724b for the second cell may indicate or include a set of parameters for communication via the second cell. The cell-specific configuration 724c for the third cell may indicate or include a set of parameters for communications via the third cell. The cell-specific parameter(s) associated with a candidate cell may include, for example, an RRC reconfiguration message, a synchronization signal configuration (e.g., an SSB configuration that indicates the time-frequency locations of SSB(s)), a random access configuration, or the like.

In certain aspects, a neighboring network entity (e.g., the second network entity 602b) may send, to a source (or another neighboring) network entity (e.g., the first network entity 602a), network entity-specific configuration(s) for the neighboring network entity and any of the candidate cells served by or at the neighboring network entity. In certain aspects, the neighboring network entity may transfer the LTM configuration(s) in response to (based on, before, after, or in association with) a request from the source (or other neighboring) network entity. As an example, referring to FIGS. 6 and 7, the second network entity 602b may send, to the first network entity 602a, the second configuration 720b and the cell-specific configuration 724c for the third cell. The first network entity 602a may prepare one or more inter-network entity LTM configuration(s) (e.g., the first configuration 720a, the second configuration 720b, and the cell-specific configurations 724a-c) based on any of the configurations 720b, 724c obtained from the second network entity. As discussed above, the first network entity may send, to the UE, the first configuration 720a, the second configuration 720b, and the cell-specific configurations 724a-c.

Accordingly, the techniques for inter-network entity LTM may enable reduced latencies, channel usage, and/or interruption time to perform a handover between network entities, such as an inter-CU handover.

### Aspects Related to Delta Signaling for Inter-Network Entity LTM

In certain aspects, the configuration(s) for inter-network entity LTM may apply delta signaling or a reference configuration associated with one or more network entities. The reference configuration may indicate or include a set of parameters that is common among multiple cells served by or at one or more network entities (for example, including the first network entity 602a and/or the second network entity 602b). For example, the reference configuration may be or include a subset of parameters for an RRC reconfiguration message. A network entity-specific configuration may be or include a reference configuration, and the cell-specific configuration for a candidate cell may be combined with the reference configuration to provide a set of parameters for communications via the respective candidate cell. The reference configuration and the cell-specific configuration may define a complete set of parameter(s) (e.g., a complete RRC reconfiguration message) for communications via a candidate cell. The configuration(s) for inter-network entity LTM may enable each of the network entities to determine whether to apply delta signaling and/or determine which parameters to segment between a reference configuration and a cell-specific configuration associated with the respective network entity. The reference configuration may be or include a first set of RRC parameter(s), and the cell-specific configuration may be or include a second set of RRC parameter(s), which may include different or non-overlapping types of parameter(s) from the first set of RRC parameter(s). In some cases, the second set of RRC parameter(s) may supplement the first set of RRC parameter(s) to form a complete set of RRC parameter(s) for a candidate cell. The first set of RRC parameters and the second set of RRC parameters may define a complete set of RRC parameters (e.g., a complete RRC reconfiguration message). In some cases, each of the reference configuration and the cell-specific configuration may be communicated via separate signaling. The UE may obtain first signaling that indicates the reference configuration for a network entity and second signaling that indicates the cell-specific configuration (e.g., a candidate configuration). In certain cases, the reference configuration and the cell-specific configuration may be communicated via the same signaling. In certain aspects, the cell-specific configuration may indicate or include a complete RRC reconfiguration message without a reference configuration in the network entity-specific configuration.

Referring to FIG. 7, the first configuration 720a may be or include a first reference configuration that is common to a first set of cells (e.g., including the first cell and/or the second cell) served by or at the first network entity. The first reference configuration and the cell-specific configuration 724a for the first cell may define a first set of parameters for communications via the first cell. The first reference configuration and the cell-specific configuration 724b for the second cell may define a second set of parameters for communications via the second cell. The second configuration 720b may be or include a second reference configuration that is common to a second set of cells (e.g., including the third cell) served by or at the second network entity. The second reference configuration and the cell-specific configuration 724c for the third cell may define a third set of parameters for communications via the third cell.

### Aspects Related to Channel State Information Configurations for Inter-Network Entity LTM

In certain aspects, the configuration(s) for inter-network entity LTM may indicate or include one or more measurement resources (e.g., one or more SSB and/or CSI-RS resources) for channel state information (CSI) and/or one or more CSI reporting configurations associated with candidate cells for inter-network entity cell changes. The configuration(s) for inter-network entity LTM may enable each of the network entities to determine the measurement configuration(s) and/or measurement reporting configurations associated with a candidate cell served at or by the respective network entity depending on the serving cell of the UE and/or possible positions of the UEs among the candidate cells. A network entity-specific configuration may indicate or include a set of CSI resources associated with a set of candidate cells. The set of CSI resources may be or include periodic, semi-persistent, and/or aperiodic CSI resources for one or more candidate cells, which may be served by or at one or more network entities. For example, when the UE is communicating via a first cell (e.g., the first cell is the serving cell of the UE), the candidate cells may include a second cell and a third cell served by or at one or more network entities, and the set of CSI resources may be arranged in time-frequency resource(s) allocated for the second cell and the third cell. A cell-specific configuration may indicate or include a configuration for reporting one or more radio measurements associated with the set of CSI resources. A radio measurement associated with a CSI resource may be or include a signal-to-interference plus noise ratio (SINR), a reference signal received power (RSRP), and/or a reference signal received quality (RSRQ) for a candidate cell. A CSI reporting configuration may indicate or include periodic, semi-persistent, and/or aperiodic reporting occasions for a radio measurement report. The CSI reporting configuration may indicate the type of radio measurements (e.g., SINR, RSRP, and/or RSRQ) to report to a network entity. The cell-specific configuration may refer to the set of CSI resources for CSI reporting.

Referring to FIG. 7, the first configuration 720a may indicate or include a CSI resource configuration that indicates a first set of CSI resources associated with candidate cell(s) of the first network entity, such as any possible candidate cell(s) served by or at the first network entity and/or the second network entity. For example, the first configuration 720a may include a common CSI resource configuration for candidate cells of the first network entity. In some cases, the first set of CSI resources may include a CSI resource (e.g., an SSB index) per candidate cell. In some cases, the first set of CSI resources may include CSI resource(s) for a set of candidate cells, when the UE is communicating via a specific candidate cell, as discussed above. For example, when a first cell is the serving cell of the UE, the first set of CSI resources may include CSI resource(s) allocated or arranged in carrier(s) of the second cell and/or the third cell. The cell-specific configuration 724a for the first cell may indicate or include a CSI reporting configuration for reporting one or more radio measurements for the first set of CSI resources. The cell-specific configuration 724b for the second cell may indicate or include a CSI reporting configuration for reporting one or more radio measurements for the first set of CSI resources and/or a second set of CSI resources indicated or included in the first configuration 720a. In certain aspects, the first configuration 720a may indicate or include a plurality of CSI resource configurations, and each of the CSI resource configurations may define a set of CSI resources associated with candidate cell(s) that depend on the serving cell of the UE.

The second configuration 720b may indicate or include a CSI resource configuration that indicates a second set of CSI resources associated with a second set of candidate cells of the second network entity, such as any possible candidate cell(s) served by or at the first network entity and/or the second network entity. The cell-specific configuration 724c for the third cell may indicate or include a CSI reporting configuration for reporting one or more radio measurements for the second set of CSI resources.

### Aspects Related to Radio Link Failure Recovery for Inter-Network Entity LTM

In certain aspects, the configuration(s) for inter-network entity LTM may indicate or include an indication of whether to perform radio link failure recovery via an LTM cell switch among candidate cells of one or more network entities. For example, when a UE detects or identifies a radio link failure for a serving cell, the UE may perform an LTM cell switch to a candidate cell among the candidate cells provided in the configuration(s) for inter-network entity LTM. The LTM cell switch may enable reduced latency for radio link failure recovery, for example, due to the UE having RRC configuration(s) for one or more candidate cells served by or at multiple network entities. The configuration(s) for inter-network entity LTM may enable each of the network entities to determine whether to apply radio link failure recovery via an LTM cell switch.

A network entity-specific configuration for inter-network entity LTM may indicate or include a specific field (e.g., attemptLTM-switch field) that provides the radio link failure recovery indication for the respective network entity. When the network-entity specific configuration includes the attemptLTM-switch field set to “true”, the network-entity specific configuration indicates to perform radio link failure recovery via an LTM cell switch among candidate cells of the respective network entity (e.g., the candidate cells provided in the network entity-specific configuration). When the network-entity specific configuration lacks the attemptLTM-switch field (or includes the attemptLTM-switch field set to “false”), the network-entity specific configuration indicates to refrain from performing radio link failure recovery via an LTM cell switch.

As an example with respect to FIG. 7, the first configuration 720a may indicate or include an indication to perform radio link failure recovery via an LTM cell switch among the candidate cells of the first network entity. The first configuration 720a may indicate or include the respective candidate cells of the first network entity, which may include the first cell, the second cell, and/or the third cell. For example, when radio link failure is detected or determined for the first cell or the second cell, the UE may perform fast radio link failure recovery via an LTM cell switch among the candidate cells of the first network entity, which may include the first cell, the second cell, and/or the third cell. The second configuration 720b may indicate or include an indication to refrain from performing radio link failure recovery via an LTM cell switch. For example, when radio link failure is detected or determined for the third cell, the UE may perform an RRC connection reestablishment, for example, via a random access procedure without an LTM cell switch.

### Aspects Related to Candidate Mapping for Inter-Network Entity LTM

In certain aspects, the configuration(s) for inter-network entity LTM may indicate or include a mapping of candidate cells to cell identifiers (or cell identities). The configuration(s) for inter-network entity LTM may enable each of the network entities to determine the candidate mappings for the possible candidates of the respective network entity. In certain cases, the configuration(s) for inter-network entity LTM may indicate or include a mapping of candidate cells to cell identifiers (or cell identities) per network entity. As an example, a network entity-specific configuration may indicate or include a set of candidate mappings associated with the respective network entity. Each candidate mapping of the set of candidate mappings may indicate an association between a candidate identifier and a cell identifier for a candidate cell of the network entity. In some cases, the candidate cell for a candidate mapping may be served by or at a different network entity than the network entity associated with the set of candidate mappings. The candidate cell(s) of a network entity may include candidate cell(s) served by or at one or more network entities. As an example with respect to FIG. 6, the candidate cells of the first network entity 602a may include the cells associated with the coverage areas 610a-c. A cell-specific configuration may indicate or include a candidate configuration for a candidate cell, and the candidate configuration may indicate or include a candidate identifier for the candidate cell and/or a cell identifier (or cell identity).

As an example with respect to FIG. 7, the first configuration 720a may indicate or include a first set of candidate mappings associated with the first network entity. For example, the first set of candidate mappings may include a first candidate mapping that indicates an association between the first cell and a first candidate identifier of the first network entity. The cell-specific configuration 724a for the first cell may indicate or include a candidate configuration that indicates the first candidate identifier. The first set of candidate mappings may include a second candidate mapping that indicates an association between the second cell and a second candidate identifier of the first network entity. The cell-specific configuration 724b for the second cell may indicate the second candidate identifier. The first set of candidate mappings may include a third candidate mapping that indicates an association between the third cell and a third candidate identifier of the first network entity. Each of the candidate identifiers for the first set of candidate mappings may have a value specific to the first configuration 720a. The first network entity may send, to a UE, an LTM cell switch command that indicates or includes a candidate identifier based on the first set of candidate mappings. For example, the first network entity may send, to the UE, an LTM cell switch command to switch to the third cell, and the LTM cell switch command may indicate the target cell for the cell switch via the third candidate identifier, which may indicate to switch to a candidate configuration for the third cell (e.g., the cell-specific configuration 724c).

The second configuration 720b may indicate or include a second set of candidate mappings associated with the second network entity. For example, the second set of candidate mappings may include a first candidate mapping that indicates an association between the third cell and a first candidate identifier of the second network entity. The cell-specific configuration 724c for the third cell may indicate or include a candidate configuration that indicates the first candidate identifier. The second set of candidate mappings may include a second candidate mapping that indicates an association between the second cell and a second candidate identifier. The second set of candidate mappings may include a third candidate mapping that indicates an association between the first cell and a third candidate identifier. Each of the candidate identifiers for the second set of candidate mappings may have a value specific to the second configuration 720b. For example, the same candidate identifier value in the first set of candidate mappings and the second set of candidate mappings may point to different cell identifiers. The second network entity may send, to a UE, an LTM cell switch command that indicates or includes a candidate identifier based on the second set of candidate mappings. For example, the second network entity may send, to the UE, an LTM cell switch command to switch to the first cell, and the LTM cell switch command may indicate the target cell for the cell switch via the third candidate identifier, which may indicate to switch to a candidate configuration for the first cell (e.g., the cell-specific configuration 724a).

Accordingly, the UE may determine which set of candidate mappings (e.g., first set of candidate mappings or second set of candidate mappings) to use to determine a cell associated with a candidate identifier received in an LTM switch command based on which network entity the LTM switch command is received from (e.g., a serving network entity of the UE). For example, where the first network entity is a serving network entity of the UE, and the LTM switch command includes a first candidate identifier value (e.g., one), the UE uses the first set of candidate mappings to determine that the first candidate identifier value maps to the first cell, and thus, the UE switches to the first cell. As another example, where the second network entity is the serving network entity of the UE, and the LTM switch command includes the first candidate identifier value (e.g., one), the UE uses the second set of candidate mappings to determine that the first candidate identifier value maps to the third cell, and thus the UE switches to the third cell.

### Aspects Related to RRC Container(s) for Inter-Network Entity LTM

In certain aspects, the configuration(s) for inter-network entity LTM may indicate or include certain RRC container(s) or configuration(s) across the network-entity specific configuration(s) and the cell-specific configuration(s). The configuration(s) for inter-network entity LTM may indicate or include RRC parameter(s) that are common to one or more cell(s) served by or at a network entity and cell-specific RRC parameter(s) and RRC parameter(s) that are specific to a candidate cell. A network entity-specific configuration may indicate or include RRC parameter(s) that are common among cells served by or at the respective network entity, and the cell-specific configuration may indicate or include RRC parameter(s) specific to the respective cell. The common RRC parameter(s) and the cell-specific RRC parameter(s) may define a complete set of RRC parameters for a candidate cell. The common RRC parameter(s) may include, for example, a discontinuous reception (DRX) configuration, a common serving cell configuration, or the like.

The network entity-specific configuration may indicate or include RRC information element(s) and/or parameter(s) that are common among cells to form a network entity related RRC container. For example, the RRC information element(s) and/or parameter(s) that are common to the cells and inside cell-specific RRC containers can be moved to the network entity-specific configuration to form a network entity RRC container. The UE may concatenate a cell-specific RRC container to the network entity RRC container to form a full or complete RRC container for the respective cell. In certain aspects, the delta signaling discussed above may be applied to the segmentation of RRC containers across a network entity RRC container and cell-specific RRC container.

Referring to FIG. 7, the first configuration 720a may indicate or include RRC parameter(s) common to a set of cells (e.g., including the first cell and/or the second cell). The cell-specific configuration 724a for the first cell may indicate or include RRC parameter(s) specific to the first cell. The common RRC parameter(s) and the cell-specific RRC parameter(s) may define a complete set of RRC parameter(s) for the first cell.

### Example Signaling for Inter-Network Entity LTM

FIG. 8 depicts a process flow 800 for signaling for inter-network entity LTM among a first network entity 802a, a second network entity 802b, and a user equipment (UE) 804. In some aspects, the network entity 802a, 802b may each be an example of the BS 102 depicted and described with respect to FIGS. 1 and 3 or a disaggregated base station depicted and described with respect to FIG. 2. In certain aspects, each of the network entities 802a, 802b may be an example of the CU 210 depicted and described with respect to FIG. 2. The first network entity 802a may be an example of the first network entity 602a of FIG. 6, and the second network entity 802b may be an example of the second network entity 602b of FIG. 6. Similarly, the UE 804 may be an example of UE 104 depicted and described with respect to FIGS. 1 and 3. However, in other aspects, UE 804 may be another type of wireless communications device and network entity 802a, 802b may be another type of network entity or network node, such as those described herein. Note that any operations or signaling illustrated with dashed lines may indicate that that operation or signaling is an optional or alternative example.

At 806, the first network entity 802a sends, to the second network entity 802b, a request for LTM configuration(s) associated with the second network entity 802b. In certain aspects, the request may be or include a handover request or a request for LTM preparation. The request may indicate or include to provide RRC parameter(s) for an LTM cell switch among candidate cells served by or at the second network entity 802b. The request may be communicated via a backhaul link, such as an F1, Xn, and/or NG interface.

At 808, the first network entity 802a obtains, from the second network entity 802b, an indication of LTM configuration(s) associated with the second network entity 802b. The LTM configuration(s) may be or include RRC parameter(s) associated with candidate cell(s) served by or at the second network entity 802b. For example, LTM configuration(s) may be or include the RRC reconfiguration message(s), the CSI resource configuration, the CSI reporting configuration, etc. for candidate cells served by or at the second network entity 802b. The LTM configuration(s) may be or include a network entity-specific configuration associated with the second network entity 802b, such as the second configuration of FIG. 7. In certain aspects, the LTM configuration(s) may be or include cell-specific configuration(s) associated with candidate cell(s) served by or at the second network entity 802b, such as the cell-specific configuration for the third cell of FIG. 7. In certain aspects, the indication of the LTM configuration(s) may be or include a response to the handover request or request for LTM preparation. The indication of the LTM configuration(s) may be communicated via a backhaul link, such as an F1, Xn, and/or NG interface.

At 810, the UE 804 obtains, from the first network entity 802a, one or more configurations for LTM among candidate cells served by or at a plurality of network entities including the first network entity 802a and the second network entity 802b. The configuration(s) may be or include network-entity specific LTM configuration(s) and cell-specific configuration(s) for the candidate cells, for example, as described herein with respect to FIG. 7. In certain aspects, the configuration(s) may include a reference configuration and a set of cell-specific parameters that supplement the reference configuration to form a complete RRC reconfiguration for a candidate cell. In certain aspects, the configuration(s) may include a CSI resource configuration associated with candidate cells of a network entity and a CSI reporting configuration associated with a candidate cell. In certain aspects, the configuration(s) may include an indication of whether to perform a radio link failure recovery via an LTM switch among the candidate cells based on the configuration(s). In certain aspects, the configuration(s) may include the candidate mappings for candidate identifiers to cell identifiers as discussed above. The configuration(s) may be communicated via RRC signaling, MAC signaling, DCI, and/or system information (e.g., SIB).

At 812, the UE 804 obtains, from the first network entity 802a, an indication of the association(s) between cell-specific configuration(s) for candidate cells and a network entity, such as the first network entity 802a or the second network entity 802b. For example, the configuration(s) obtained at 810 may include a first cell-specific configuration for a first cell served by or at the first network entity 802a and a second cell-specific configuration for a second cell served by or at the second network entity 802b. The indication of the association(s) may indicate that the first cell-specific configuration is associated with the first network entity 802a and that the second cell-specific configuration is associated with the second network entity 802b. The association(s) may enable the UE 804 to determine which network entity-specific configuration(s) and/or cell-specific configuration(s) to use for communications with a network entity via a candidate cell served at or by the network entity. The indication of the association(s) may be communicated via RRC signaling, MAC signaling, DCI, and/or system information. In certain aspects, the configuration(s) obtained at 810 may indicate or include the indication of the associations between cell-specific configuration(s) and the network entity.

At 814, the UE 804 obtains, from the first network entity 802a and/or the second network entity 802b, an indication of identifier(s) for the first network entity 802a and/or the second network entity 802b. In certain aspects, the identifier(s) for the first network entity 802a and/or the second network entity 802b may be associated with certain configuration(s) obtained at 810. For example, a first network entity-specific configuration for the first network entity 802a obtained at 810 may indicate or include a first identifier for the first network entity 802a, and a second network entity-specific configuration for the second network entity 802b obtained at 810 may indicate or include a second identifier for the first network entity 802a. In some cases, the configuration(s) obtained at 810 may include the indication of the identifier(s). In certain aspects, the indication of the identifier(s) may be communicated via separate signaling from the signaling that carries the configuration(s) obtained at 810. As an example, the UE 804 may obtain the indication of the identifier(s) for the first network entity 802a and/or the second network entity 802b via system information, and the UE 804 may use the identifier for the first network entity 802a to select the corresponding configuration(s) associated with the first network entity 802a and/or candidate cells served by or at the first network entity 802a for communications with the first network entity 802a, or vice versa. In certain cases, the UE 804 may obtain the indication of the identifier for the first network entity 802a from the first network entity 802a, and the UE 804 may obtain the indication of the identifier for the second network entity 802b from the second network entity 802b. The indication of the identifier(s) may be communicated via RRC signaling, MAC signaling, DCI, and/or system information.

At 816, the UE 804 may obtain, from the second network entity 802b, reference signal(s) at certain measurement occasion(s), for example, based on the configuration(s) obtained at 810. The UE 804 may obtain the reference signal(s) at periodic measurement occasions (e.g., measurement gaps). The reference signal(s) may be communicated in time-frequency resource(s) associated with candidate cell(s) served by or at the second network entity 802b. The UE 804 may obtain radio measurement(s) for the reference signal(s), such as radio measurements including an SINR, RSRP, and/or RSRQ for the reference signal(s). The reference signal(s) may include an SSB, CSI-RS, DM-RS, and/or any other suitable reference signal.

At 818, the UE 804 sends, to the first network entity 802a, a measurement report that indicates the radio measurement(s) associated with the candidate cell(s) served at or by the second network entity 802b. The measurement report may include the radio measurements according to the configuration(s) obtained at 810. The UE 804 may report the measurement report in a reporting occasion allocated according to the configuration(s) obtained at 810. As an example, the measurement report may indicate that the channel conditions are better for certain candidate(s) cell(s) of the second network entity 802b compared to the channel conditions for the first network entity 802a.

At 820, the UE 804 obtains, from the first network entity 802a, an LTM cell switch command via L1 and/or L2 signaling, for example, as described herein with respect to FIG. 5A. The LTM cell switch command may indicate to change a serving cell of the UE 804 to a candidate cell served by or at the second network entity 802b. The LTM cell switch command may indicate to switch from communicating with the first network entity 802a to communicating with the second network entity 802b via a candidate cell served by or at the second network entity 802b. In certain aspects, the LTM cell switch command may indicate or include a candidate identifier to indicate the target cell of the LTM cell switch or handover. The candidate identifier may be based on the candidate mapping associated with the first network entity 802a as discussed above. In certain aspects, the LTM cell switch command may indicate or include an identifier for the second network entity 802b to indicate the target network entity for the LTM cell switch or handover. In certain aspects, the LTM cell switch command may trigger the UE 804 to obtain the indication of the identifier for the second network entity 802b. For example, the UE 804 may obtain the indication of the identifier for the second network entity 802b from the second network entity 802b after obtaining the LTM cell switch command.

At 822, the UE 804 communicates with the second network entity 802b in accordance with a candidate configuration associated with the target cell of the LTM cell switch command. The UE 804 may communicate with the second network entity 802b via the target cell based on the configuration(s) obtained at 810. In some cases, the LTM cell switch command may trigger the UE 804 to perform a RACH procedure (e.g., a contention-free random access procedure) to initiate communications with the second network entity 802b, for example, when the UE 804 does not have a valid timing advance for the target cell. In certain cases, the LTM cell switch command may trigger the UE 804 to perform a RACH-less LTM, for example, when the UE 804 has a valid timing advance for the target cell. The inter-network entity LTM cell switch may reduce the latency, channel usage, and/or interruption time to handover from the first network entity 802a to the second network entity 802b.

Note that the mobility operations illustrated in FIG. 8 are an example of inter-network entity mobility triggered by an LTM cell switch command, and aspects of the present disclosure may be applied to any of other types LTM operations discussed herein, such as radio link failure recovery via an LTM cell switch. Note that the operations and signaling illustrated in FIG. 8 is described herein to facilitate an understanding of inter-network entity LTM, and aspects of the present disclosure may be performed in various manners via alternative or additional signaling and/or operations. In certain aspects, the operations and/or signaling of FIG. 8 may occur in an order different from that described, and various actions may be added, omitted, or combined.

### Example Operations for Inter-Network Entity Lower Layer Triggered Mobility

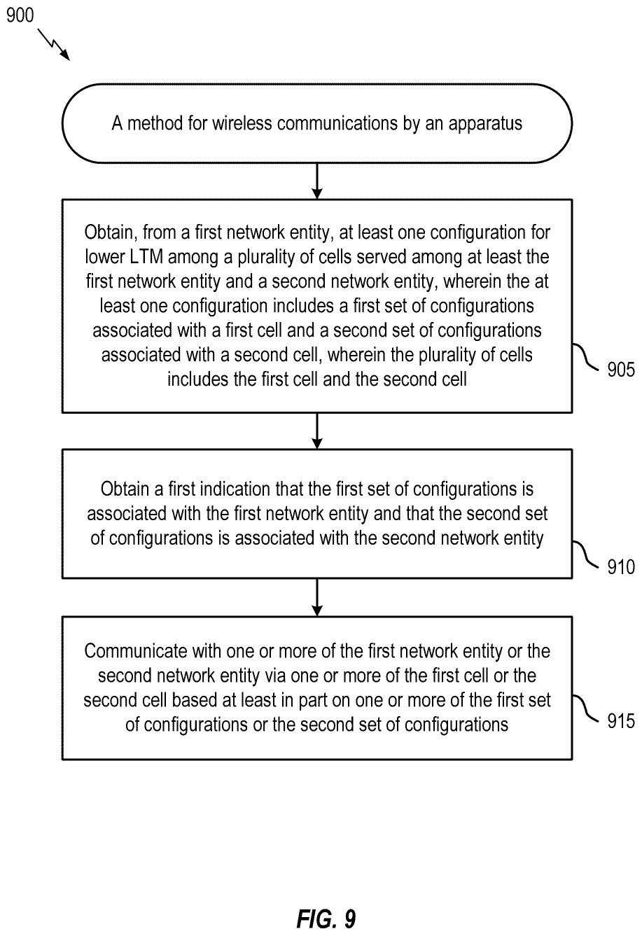

FIG. 9 shows a method 900 for wireless communications by an apparatus, such as UE 104 of FIGS. 1 and 3.

Method 900 begins at block 905 with obtaining, from a first network entity, at least one configuration for LTM among a plurality of cells served among at least the first network entity and a second network entity, wherein the at least one configuration includes a first set of configurations associated with a first cell and a second set of configurations associated with a second cell, wherein the plurality of cells includes the first cell and the second cell, for example, as described herein with respect to FIGS. 7 and 8. The first network entity may be an example of the first network entity 602a of FIG. 6; and the second network entity may be an example of the second network entity 602b of FIG. 6.

Method 900 then proceeds to block 910 with obtaining a first indication that the first set of configurations is associated with the first network entity and that the second set of configurations is associated with the second network entity, for example, as described herein with respect to FIGS. 7 and 8. In certain aspects, the at least one configuration comprises the first indication. The first set of configurations may be an example of the first configuration 720a and/or the cell-specific configuration(s) 724a, 724b of FIG. 7; and the second set of configurations may be an example of the second configuration 720b and/or the cell-specific configuration(s) 724c of FIG. 7.

Method 900 then proceeds to block 915 with communicating with one or more of the first network entity or the second network entity via one or more of the first cell or the second cell based at least in part on one or more of the first set of configurations or the second set of configurations. In certain aspects, block 915 includes switching from communicating with the first network entity via the first cell to communicating with the second network entity via the second cell based at least in part on the second set of configurations associated with the second cell, for example, as described herein with respect to FIGS. 7 and 8.

In certain aspects, method 900 further includes obtaining, from the first network entity, lower layer signaling that indicates to perform a cell switch to the second cell of the second network entity. In certain aspects, the lower layer signaling indicates to communicate with the second network entity via the second cell based at least in part on the second set of configurations including one or more RRC configurations. In certain aspects, the lower layer signaling comprises one or more of DCI or MAC signaling. In certain aspects, the lower layer signaling comprises one or more of L1 signaling or L2 signaling.

In certain aspects, the at least one configuration comprises a first reference configuration that is common to a first set of cells of the first network entity; the first set of cells includes the first cell; the first set of configurations comprises a first set of parameters; and the first reference configuration and the first set of parameters define a second set of parameters associated with the first cell.

In certain aspects, the at least one configuration comprises a second reference configuration that is common to a second set of cells of the second network entity; the second set of cells includes the second cell; the second set of configurations comprises a third set of parameters; and the second reference configuration and the third set of parameters define a fourth set of parameters associated with the second cell.

In certain aspects, the at least one configuration comprises a first configuration that indicates a first set of CSI resources associated with a first set of candidate cells of the first network entity; the first set of candidate cells includes one or more of the first cell or the second cell; and the first set of configurations comprises a second configuration for reporting one or more radio measurements associated with the first set of CSI resources.

In certain aspects, the at least one configuration comprises an indication to recover from a radio link failure, using the at least one configuration, via a cell switch among at least a first set of cells of the first network entity; and the first set of cells includes the first cell.

In certain aspects, the at least one configuration comprises an indication to refrain from recovering from a radio link failure, using the at least one configuration, via a cell switch among a second set of cells of the second network entity; and the second set of cells includes the second cell.

In certain aspects, the at least one configuration includes, for each cell of the plurality of cells, at least one mapping between a candidate identifier and a cell identifier for the respective cell; one or more first candidate identifiers are associated with the first set of configurations; and one or more second candidate identifiers are associated with the second set of configurations.

In certain aspects, the at least one configuration comprises: a first set of candidate mappings associated with the first network entity; and a second set of candidate mappings associated with the second network entity; each candidate mapping of the first set of candidate mappings and the second set of mappings indicates an association between a candidate identifier and a cell identifier for a cell; and the method 900 further comprises: obtaining, from the first network entity, first signaling that indicates a first candidate identifier; and communicating in a third cell based on the first set of candidate mappings that maps the first candidate identifier to the cell identifier of the third cell.

In certain aspects, method 900 further includes obtaining, from the second network entity, second signaling that indicates the first candidate identifier. In certain aspects, method 900 further includes communicating in a fourth cell based on the second set of candidate mappings that maps the first candidate identifier to the cell identifier of the fourth cell.

In certain aspects, the at least one configuration comprises a first configuration that is common to a first set of cells for communications with the first network entity; and the first set of cells includes the first cell.

In certain aspects, method 900 further includes obtaining a second indication of one or more of a first identifier for the first network entity or a second identifier for the second network entity. In certain aspects, the at least one configuration comprises the second indication. In certain aspects, the first indication indicates the first set of configurations is associated with the first identifier for the first network entity. In certain aspects, the first indication indicates the first set of configurations is associated with a first list of cell identifiers for a first set of cells of the first network entity; and the first set of cells includes the first cell. In certain aspects, obtaining the second indication comprises obtaining, from the first network entity, the second indication via one or more of a cell switch command or system information.

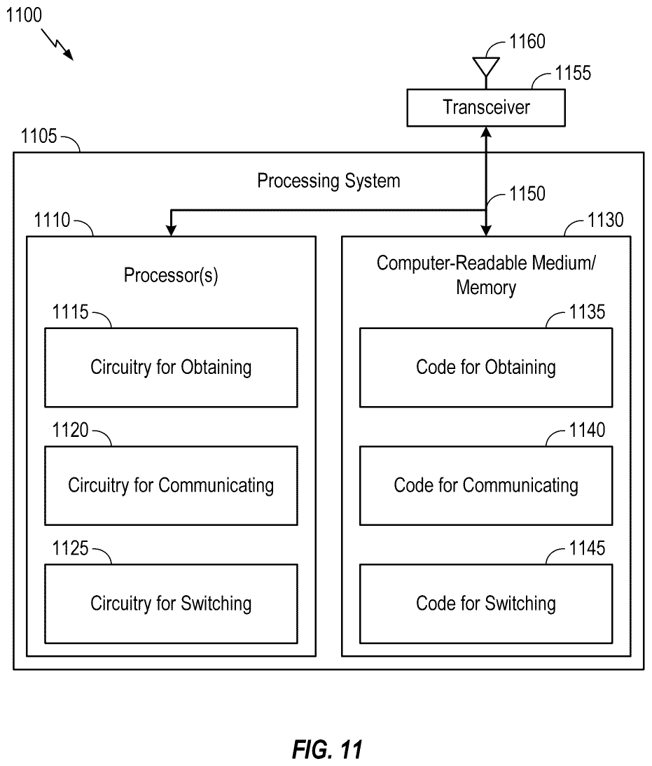

In certain aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

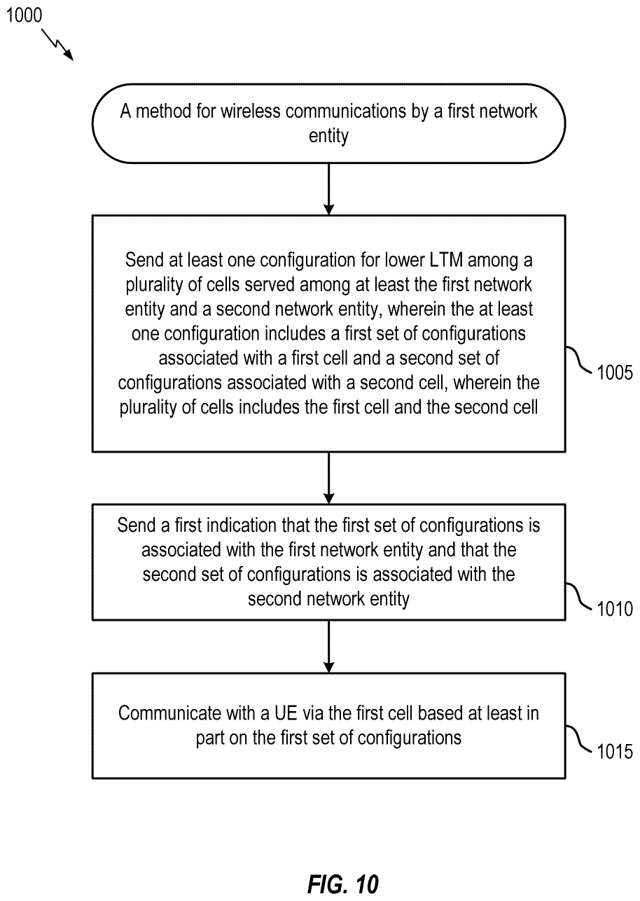

FIG. 10 shows a method 1000 for wireless communications by a first network entity, such as BS 102 of FIGS. 1 and 3, or a disaggregated base station as discussed with respect to FIG. 2. In certain aspects, the first network entity may be an example of the first network entity 602a of FIG. 6.

Method 1000 begins at block 1005 with sending at least one configuration for LTM among a plurality of cells served among at least the first network entity and a second network entity, wherein the at least one configuration includes a first set of configurations associated with a first cell and a second set of configurations associated with a second cell, wherein the plurality of cells includes the first cell and the second cell, for example, as described herein with respect to FIGS. 7 and 8. In certain aspects, the second network entity may be an example of the second network entity 602b of FIG. 6.

Method 1000 then proceeds to block 1010 with sending a first indication that the first set of configurations is associated with the first network entity and that the second set of configurations is associated with the second network entity, for example, as described herein with respect to FIGS. 7 and 8. In certain aspects, the at least one configuration comprises the first indication.

Method 1000 then proceeds to block 1015 with communicating with a UE via the first cell based at least in part on the first set of configurations, for example, as described herein with respect to FIGS. 7 and 8.

In certain aspects, method 1000 further includes sending lower layer signaling that indicates to perform a cell switch to the second cell of the second network entity. In certain aspects, the lower layer signaling indicates to communicate with the second network entity via the second cell based at least in part on the second set of configurations including one or more RRC configurations. In certain aspects, the lower layer signaling comprises one or more of DCI or MAC signaling. In certain aspects, the lower layer signaling comprises one or more of L1 signaling or L2 signaling.

In certain aspects, the at least one configuration comprises a first reference configuration that is common to a first set of cells of the first network entity; the first set of cells includes the first cell; the first set of configurations comprises a first set of parameters; and the first reference configuration and the first set of parameters define a second set of parameters associated with the first cell.

In certain aspects, the at least one configuration comprises a second reference configuration that is common to a second set of cells of the second network entity; the second set of cells includes the second cell; the second set of configurations comprises a third set of parameters; and the second reference configuration and the third set of parameters define a fourth set of parameters associated with the second cell.

In certain aspects, the at least one configuration comprises a first configuration that indicates a first set of CSI resources associated with a first set of candidate cells of the first network entity; the first set of candidate cells includes one or more of the first cell or the second cell; and the first set of configurations comprises a second configuration for reporting one or more radio measurements associated with the first set of CSI resources.

In certain aspects, the at least one configuration comprises an indication to recover from a radio link failure, using the at least one configuration, via a cell switch among at least a first set of cells of the first network entity; and the first set of cells includes the first cell. In certain aspects, the at least one configuration comprises an indication to refrain from recovering from a radio link failure, using the at least one configuration, via a cell switch among a second set of cells of the second network entity; and the second set of cells includes the second cell.

In certain aspects, the at least one configuration includes, for each cell of the plurality of cells, at least one mapping between a candidate identifier and a cell identifier for the respective cell; one or more first candidate identifiers are associated with the first set of configurations; and one or more second candidate identifiers are associated with the second set of configurations.

In certain aspects, the at least one configuration comprises: a first set of candidate mappings associated with the first network entity; and a second set of candidate mappings associated with the second network entity; each candidate mapping of the first set of candidate mappings and the second set of mappings indicates an association between a candidate identifier and a cell identifier for a cell; and the method 1000 further comprises: sending first signaling that indicates a first candidate identifier; and communicating in a third cell based on the first set of candidate mappings that maps the first candidate identifier to the cell identifier of the third cell.

In certain aspects, the at least one configuration comprises a first configuration that is common to a first set of cells for communications with the first network entity; and the first set of cells includes the first cell.

In certain aspects, method 1000 further includes sending a second indication of one or more of a first identifier for the first network entity or a second identifier for the second network entity. In certain aspects, the at least one configuration comprises the second indication. In certain aspects, the first indication indicates the first set of configurations is associated with the first identifier for the first network entity. In certain aspects, the first indication indicates the first set of configurations is associated with a first list of cell identifiers for a first set of cells of the first network entity; and the first set of cells includes the first cell. In certain aspects, obtaining the second indication comprises sending the second indication via one or more of a cell switch command or system information.

In certain aspects, method 1000 further includes sending, to the second network entity, a request for an LTM configuration associated with the second network entity. In certain aspects, method 1000 further includes obtaining, from the second network entity, an indication of the LTM configuration associated with the second network entity, the LTM configuration comprising the second set of configurations associated with the second cell.

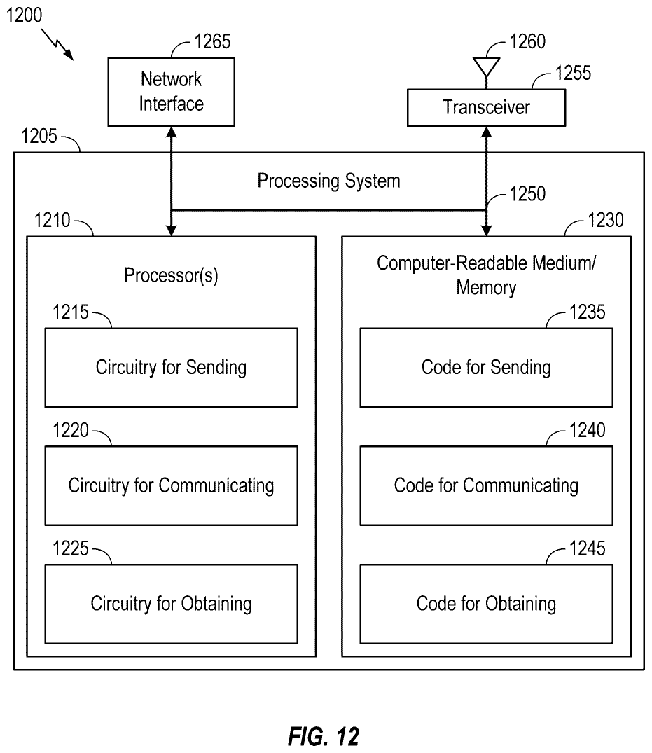

In certain aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Communications Devices

FIG. 11 depicts aspects of an example communications device 1100. In some aspects, communications device 1100 is a user equipment, such as UE 104 described above with respect to FIGS. 1 and 3.

The communications device 1100 includes a processing system 1105 coupled to a transceiver 1155 (e.g., a transmitter and/or a receiver). The transceiver 1155 is configured to transmit and receive signals for the communications device 1100 via an antenna 1160, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. The one or more processors 1110 are coupled to a computer-readable medium/memory 1130 via a bus 1150. In certain aspects, the computer-readable medium/memory 1130 is configured to store instructions (e.g., computer-executable code) that when executed by the one or more processors 1110, enable and cause the one or more processors 1110 to perform the method 900 described with respect to FIG. 9, or any aspect related to it, including any operations described in relation to FIG. 9. Note that reference to a processor performing a function of communications device 1100 may include one or more processors performing that function of communications device 1100, such as in a distributed fashion.

In the depicted example, computer-readable medium/memory 1130 stores code for obtaining 1135, code for communicating 1140, and code for switching 1145. Processing of the code 1135-1145 may enable and cause the communications device 1100 to perform the method 900 described with respect to FIG. 9, or any aspect related to it.

The one or more processors 1110 include circuitry configured to implement (e.g., execute) the code stored in the computer-readable medium/memory 1130, including circuitry for obtaining 1115, circuitry for communicating 1120, and circuitry for switching 1125. Processing with circuitry 1115-1125 may enable and cause the communications device 1100 to perform the method 900 described with respect to FIG. 9, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1155 and/or antenna 1160 of the communications device 1100 in FIG. 11, and/or one or more processors 1110 of the communications device 1100 in FIG. 11. Means for communicating, receiving or obtaining may include the transceivers 354, antenna(s) 352, receive processor 358, AI processor 370, and/or controller/processor 380 of the UE 104 illustrated in FIG. 3, transceiver 1155 and/or antenna 1160 of the communications device 1100 in FIG. 11, and/or one or more processors 1110 of the communications device 1100 in FIG. 11.

FIG. 12 depicts aspects of an example communications device 1200. In some aspects, communications device 1200 is a network entity, such as BS 102 of FIGS. 1 and 3, or a disaggregated base station as discussed with respect to FIG. 2.

The communications device 1200 includes a processing system 1205 coupled to a transceiver 1255 (e.g., a transmitter and/or a receiver) and/or a network interface 1265. The transceiver 1255 is configured to transmit and receive signals for the communications device 1200 via an antenna 1260, such as the various signals as described herein. The network interface 1265 is configured to obtain and send signals for the communications device 1200 via communications link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210. In various aspects, one or more processors 1210 may be representative of one or more of receive processor 338, transmit processor 320, TX MIMO processor 330, and/or controller/processor 340, as described with respect to FIG. 3. The one or more processors 1210 are coupled to a computer-readable medium/memory 1230 via a bus 1250. In certain aspects, the computer-readable medium/memory 1230 is configured to store instructions (e.g., computer-executable code) that when executed by the one or more processors 1210, enable and cause the one or more processors 1210 to perform the method 1000 described with respect to FIG. 10, or any aspect related to it, including any operations described in relation to FIG. 10. Note that reference to a processor of communications device 1200 performing a function may include one or more processors of communications device 1200 performing that function, such as in a distributed fashion.

In the depicted example, the computer-readable medium/memory 1230 stores code for sending 1235, code for communicating 1240, and code for obtaining 1245. Processing of the code 1235-1245 may enable and cause the communications device 1200 to perform the method 1000 described with respect to FIG. 10, or any aspect related to it.

The one or more processors 1210 include circuitry configured to implement (e.g., execute) the code stored in the computer-readable medium/memory 1230, including circuitry for sending 1215, circuitry for communicating 1220, and circuitry for obtaining 1225. Processing with circuitry 1215-1225 may enable and cause the communications device 1200 to perform the method 1000 described with respect to FIG. 10, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1255, antenna 1260, and/or network interface 1265 of the communications device 1200 in FIG. 12, and/or one or more processors 1210 of the communications device 1200 in FIG. 12. Means for communicating, receiving or obtaining may include the transceivers 332, antenna(s) 334, receive processor 338, AI processor 318, and/or controller/processor 340 of the BS 102 illustrated in FIG. 3, transceiver 1255, antenna 1260, and/or network interface 1265 of the communications device 1200 in FIG. 12, and/or one or more processors 1210 of the communications device 1200 in FIG. 12.

### Example Clauses

Implementation examples are described in the following numbered clauses:

Clause 1: A method for wireless communications by a user equipment (UE) comprising: obtaining, from a first network entity, at least one configuration for LTM among a plurality of cells served among at least the first network entity and a second network entity, wherein the at least one configuration includes a first set of configurations associated with a first cell and a second set of configurations associated with a second cell, wherein the plurality of cells includes the first cell and the second cell; obtaining a first indication that the first set of configurations is associated with the first network entity and that the second set of configurations is associated with the second network entity; and communicating with one or more of the first network entity or the second network entity via one or more of the first cell or the second cell based at least in part on one or more of the first set of configurations or the second set of configurations.

Clause 2: The method of Clause 1, further comprising obtaining, from the first network entity, lower layer signaling that indicates to perform a cell switch to the second cell of the second network entity.

Clause 3: The method of Clause 2, wherein the lower layer signaling indicates to communicate with the second network entity via the second cell based at least in part on the second set of configurations including one or more RRC configurations.

Clause 4: The method of Clause 2 or 3, wherein the lower layer signaling comprises one or more of DCI or MAC signaling.

Clause 5: The method of any one of Clauses 2-4, wherein the lower layer signaling comprises one or more of L1 signaling or L2 signaling.

Clause 6: The method of any one of Clauses 1-5, wherein communicating with one or more of the first network entity or the second network entity comprises switching from communicating with the first network entity via the first cell to communicating with the second network entity via the second cell based at least in part on the second set of configurations associated with the second cell.

Clause 7: The method of any one of Clauses 1-6, wherein: the at least one configuration comprises a first reference configuration that is common to a first set of cells of the first network entity; the first set of cells includes the first cell; the first set of configurations comprises a first set of parameters; and the first reference configuration and the first set of parameters define a second set of parameters associated with the first cell.

Clause 8: The method of Clause 7, wherein: the at least one configuration comprises a second reference configuration that is common to a second set of cells of the second network entity; the second set of cells includes the second cell; the second set of configurations comprises a third set of parameters; and the second reference configuration and the third set of parameters define a fourth set of parameters associated with the second cell.

Clause 9: The method of any one of Clauses 1-8, wherein: the at least one configuration comprises a first configuration that indicates a first set of CSI resources associated with a first set of candidate cells of the first network entity; the first set of candidate cells includes one or more of the first cell or the second cell; and the first set of configurations comprises a second configuration for reporting one or more radio measurements associated with the first set of CSI resources.

Clause 10: The method of any one of Clauses 1-9, wherein: the at least one configuration comprises an indication to recover from a radio link failure, using the at least one configuration, via a cell switch among at least a first set of cells of the first network entity; and the first set of cells includes the first cell.

Clause 11: The method of Clause 10, wherein: the at least one configuration comprises an indication to refrain from recovering from a radio link failure, using the at least one configuration, via a cell switch among a second set of cells of the second network entity; and the second set of cells includes the second cell.

Clause 12: The method of any one of Clauses 1-11, wherein: the at least one configuration includes, for each cell of the plurality of cells, at least one mapping between a candidate identifier and a cell identifier for the respective cell; one or more first candidate identifiers are associated with the first set of configurations; and one or more second candidate identifiers are associated with the second set of configurations.

Clause 13: The method of any one of Clauses 1-12, wherein: the at least one configuration comprises: a first set of candidate mappings associated with the first network entity; and a second set of candidate mappings associated with the second network entity; each candidate mapping of the first set of candidate mappings and the second set of mappings indicates an association between a candidate identifier and a cell identifier for a cell; and the method further comprises: obtaining, from the first network entity, first signaling that indicates a first candidate identifier; and communicating in a third cell based on the first set of candidate mappings that maps the first candidate identifier to the cell identifier of the third cell.

Clause 14: The method of Clause 13, further comprising: obtaining, from the second network entity, second signaling that indicates the first candidate identifier; and communicating in a fourth cell based on the second set of candidate mappings that maps the first candidate identifier to the cell identifier of the fourth cell.

Clause 15: The method of any one of Clauses 1-14, wherein: the at least one configuration comprises a first configuration that is common to a first set of cells for communications with the first network entity; and the first set of cells includes the first cell.

Clause 16: The method of any one of Clauses 1-15, wherein the at least one configuration comprises the first indication.

Clause 17: The method of any one of Clauses 1-16, further comprising obtaining a second indication of one or more of a first identifier for the first network entity or a second identifier for the second network entity.

Clause 18: The method of Clause 17, wherein the at least one configuration comprises the second indication.

Clause 19: The method of Clause 17 or 18, wherein the first indication indicates the first set of configurations is associated with the first identifier for the first network entity.

Clause 20: The method of any one of Clauses 17-19, wherein: the first indication indicates the first set of configurations is associated with a first list of cell identifiers for a first set of cells of the first network entity; and the first set of cells includes the first cell.

Clause 21: The method of any one of Clauses 17-20, wherein obtaining the second indication comprises obtaining, from the first network entity, the second indication via one or more of a cell switch command or system information.

Clause 22: A method for wireless communications by a first network entity comprising: sending at least one configuration for LTM among a plurality of cells served among at least the first network entity and a second network entity, wherein the at least one configuration includes a first set of configurations associated with a first cell and a second set of configurations associated with a second cell, wherein the plurality of cells includes the first cell and the second cell; sending a first indication that the first set of configurations is associated with the first network entity and that the second set of configurations is associated with the second network entity; and communicating with a UE via the first cell based at least in part on the first set of configurations.

Clause 23: The method of Clause 22, further comprising sending lower layer signaling that indicates to perform a cell switch to the second cell of the second network entity.

Clause 24: The method of Clause 23, wherein the lower layer signaling indicates to communicate with the second network entity via the second cell based at least in part on the second set of configurations including one or more RRC configurations.

Clause 25: The method of Clause 23 or 24, wherein the lower layer signaling comprises one or more of DCI or MAC signaling.

Clause 26: The method of any one of Clauses 23-25, wherein the lower layer signaling comprises one or more of L1 signaling or L2 signaling.

Clause 27: The method of any one of Clauses 22-26, wherein: the at least one configuration comprises a first reference configuration that is common to a first set of cells of the first network entity; the first set of cells includes the first cell; the first set of configurations comprises a first set of parameters; and the first reference configuration and the first set of parameters define a second set of parameters associated with the first cell.

Clause 28: The method of Clause 27, wherein: the at least one configuration comprises a second reference configuration that is common to a second set of cells of the second network entity; the second set of cells includes the second cell; the second set of configurations comprises a third set of parameters; and the second reference configuration and the third set of parameters define a fourth set of parameters associated with the second cell.

Clause 29: The method of any one of Clauses 22-28, wherein: the at least one configuration comprises a first configuration that indicates a first set of CSI resources associated with a first set of candidate cells of the first network entity; the first set of cells includes one or more of the first cell or the second cell; and the first set of configurations comprises a second configuration for reporting one or more radio measurements associated with the first set of CSI resources.

Clause 30: The method of any one of Clauses 22-29, wherein: the at least one configuration comprises an indication to recover from a radio link failure, using the at least one configuration, via a cell switch among at least a first set of cells of the first network entity; and the first set of cells includes the first cell.

Clause 31: The method of Clause 30, wherein: the at least one configuration comprises an indication to refrain from recovering from a radio link failure, using the at least one configuration, via a cell switch among a second set of cells of the second network entity; and the second set of cells includes the second cell.

Clause 32: The method of any one of Clauses 22-31, wherein: the at least one configuration includes, for each cell of the plurality of cells, at least one mapping between a candidate identifier and a cell identifier for the respective cell; one or more first candidate identifiers are associated with the first set of configurations; and one or more second candidate identifiers are associated with the second set of configurations.

Clause 33: The method of any one of Clauses 22-32, wherein: the at least one configuration comprises: a first set of candidate mappings associated with the first network entity; and a second set of candidate mappings associated with the second network entity; each candidate mapping of the first set of candidate mappings and the second set of mappings indicates an association between a candidate identifier and a cell identifier for a cell; and the method further comprises: sending first signaling that indicates a first candidate identifier; and communicating in a third cell based on the first set of candidate mappings that maps the first candidate identifier to the cell identifier of the third cell.

Clause 34: The method of any one of Clauses 22-33, wherein: the at least one configuration comprises a first configuration that is common to a first set of cells for communications with the first network entity; and the first set of cells includes the first cell.

Clause 35: The method of any one of Clauses 22-34, wherein the at least one configuration comprises the first indication.

Clause 36: The method of any one of Clauses 22-35, further comprising sending a second indication of one or more of a first identifier for the first network entity or a second identifier for the second network entity.

Clause 37: The method of Clause 36, wherein the at least one configuration comprises the second indication.

Clause 38: The method of Clause 36 or 37, wherein the first indication indicates the first set of configurations is associated with the first identifier for the first network entity.

Clause 39: The method of any one of Clauses 36-38, wherein: the first indication indicates the first set of configurations is associated with a first list of cell identifiers for a first set of cells of the first network entity; and the first set of cells includes the first cell.

Clause 40: The method of any one of Clauses 36-39, wherein obtaining the second indication comprises sending the second indication via one or more of a cell switch command or system information.

Clause 41: The method of any one of Clauses 22-40, further comprising: sending, to the second network entity, a request for an LTM configuration associated with the second network entity; and obtaining, from the second network entity, an indication of the LTM configuration associated with the second network entity, the LTM configuration comprising the second set of configurations associated with the second cell.

Clause 42: One or more apparatuses, comprising: one or more memories comprising executable instructions; and one or more processors configured to execute the executable instructions and cause the one or more apparatuses to perform a method in accordance with any one of Clauses 1-41.

Clause 43: One or more apparatuses, comprising: one or more memories; and one or more processors, coupled to the one or more memories, configured to cause the one or more apparatuses to perform a method in accordance with any one of Clauses 1-41.

Clause 44: One or more apparatuses, comprising: one or more memories; and one or more processors, coupled to the one or more memories, configured to perform a method in accordance with any one of Clauses 1-41.

Clause 45: One or more apparatuses, comprising means for performing a method in accordance with any one of Clauses 1-41.

Clause 46: One or more non-transitory computer-readable media comprising executable instructions that, when executed by one or more processors of one or more apparatuses, cause the one or more apparatuses to perform a method in accordance with any one of Clauses 1-41.

Clause 47: One or more computer program products embodied on one or more computer-readable storage media comprising code for performing a method in accordance with any one of Clauses 1-41.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one or more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause a user equipment (UE) to:
obtain, from a first network entity, at least one configuration for lower layer triggered mobility (LTM) among a plurality of cells served among at least the first network entity and a second network entity, wherein the at least one configuration includes a first set of configurations associated with a first cell and a second set of configurations associated with a second cell, wherein the plurality of cells includes the first cell and the second cell;
obtain a first indication that the first set of configurations is associated with the first network entity and that the second set of configurations is associated with the second network entity; and
communicate with one or more of the first network entity or the second network entity via one or more of the first cell or the second cell based at least in part on one or more of the first set of configurations or the second set of configurations.

2. The apparatus of claim 1, wherein the one or more processors are configured to cause the UE to obtain, from the first network entity, lower layer signaling that indicates to perform a cell switch to the second cell of the second network entity.

3. The apparatus of claim 1, wherein:
the at least one configuration comprises a first reference configuration that is common to a first set of cells of the first network entity;
the first set of cells includes the first cell;
the first set of configurations comprises a first set of parameters; and
the first reference configuration and the first set of parameters define a second set of parameters associated with the first cell.

4. The apparatus of claim 3, wherein:
the at least one configuration comprises a second reference configuration that is common to a second set of cells of the second network entity;
the second set of cells includes the second cell;
the second set of configurations comprises a third set of parameters; and
the second reference configuration and the third set of parameters define a fourth set of parameters associated with the second cell.

5. The apparatus of claim 1, wherein:
the at least one configuration comprises a first configuration that indicates a first set of channel state information (CSI) resources associated with a first set of candidate cells of the first network entity;
the first set of candidate cells includes one or more of the first cell or the second cell; and
the first set of configurations comprises a second configuration for reporting one or more radio measurements associated with the first set of CSI resources.

6. The apparatus of claim 1, wherein:
the at least one configuration comprises an indication to recover from a radio link failure, using the at least one configuration, via a cell switch among at least a first set of cells of the first network entity; and
the first set of cells includes the first cell.

7. The apparatus of claim 6, wherein:
the at least one configuration comprises an indication to refrain from recovering from a radio link failure, using the at least one configuration, via a cell switch among a second set of cells of the second network entity; and
the second set of cells includes the second cell.

8. The apparatus of claim 1, wherein:
the at least one configuration includes, for each cell of the plurality of cells, at least one mapping between a candidate identifier and a cell identifier for the respective cell;
one or more first candidate identifiers are associated with the first set of configurations; and
one or more second candidate identifiers are associated with the second set of configurations.

9. The apparatus of claim 1, wherein the one or more processors are configured to cause the UE to obtain a second indication of one or more of a first identifier for the first network entity or a second identifier for the second network entity.

10. An apparatus configured for wireless communications, comprising:
one or more memories; and
one or more processors coupled to the one or more memories, the one or more processors being configured to cause a first network entity to:
send at least one configuration for lower layer triggered mobility (LTM) among a plurality of cells served among at least the first network entity and a second network entity, wherein the at least one configuration includes a first set of configurations associated with a first cell and a second set of configurations associated with a second cell, wherein the plurality of cells includes the first cell and the second cell;
send a first indication that the first set of configurations is associated with the apparatus and that the second set of configurations is associated with the second network entity; and
communicate with a user equipment (UE) via the first cell based at least in part on the first set of configurations.

11. The apparatus of claim 10, wherein the one or more processors are configured to cause the apparatus to send lower layer signaling that indicates to perform a cell switch to the second cell of the second network entity.

12. The apparatus of claim 10, wherein:
the at least one configuration comprises a first reference configuration that is common to a first set of cells of the first network entity;
the first set of cells includes the first cell;
the first set of configurations comprises a first set of parameters; and
the first reference configuration and the first set of parameters define a second set of parameters associated with the first cell.

13. The apparatus of claim 12, wherein:
the at least one configuration comprises a second reference configuration that is common to a second set of cells of the second network entity;
the second set of cells includes the second cell;
the second set of configurations comprises a third set of parameters; and
the second reference configuration and the third set of parameters define a fourth set of parameters associated with the second cell.

14. The apparatus of claim 10, wherein:
the at least one configuration comprises a first configuration that indicates a first set of channel state information (CSI) resources associated with a first set of candidate cells of the first network entity;
the first set of candidate cells includes one or more of the first cell or the second cell; and
the first set of configurations comprises a second configuration for reporting one or more radio measurements associated with the first set of CSI resources.

15. The apparatus of claim 10, wherein:
the at least one configuration comprises an indication to recover from a radio link failure, using the at least one configuration, via a cell switch among at least a first set of cells of the apparatus; and
the first set of cells includes the first cell.

16. The apparatus of claim 15, wherein:
the at least one configuration comprises an indication to refrain from recovering from a radio link failure, using the at least one configuration, via a cell switch among a second set of cells of the second network entity; and
the second set of cells includes the second cell.

17. The apparatus of claim 10, wherein:
the at least one configuration includes, for each cell of the plurality of cells, at least one mapping between a candidate identifier and a cell identifier for the respective cell;
one or more first candidate identifiers are associated with the first set of configurations; and
one or more second candidate identifiers are associated with the second set of configurations.

18. The apparatus of claim 10, wherein the one or more processors are configured to cause the first network entity to send a second indication of one or more of a first identifier for the first network entity or a second identifier for the second network entity.

19. The apparatus of claim 10, wherein the one or more processors are configured to cause the first network entity to:
send, to the second network entity, a request for an LTM configuration associated with the second network entity; and
obtain, from the second network entity, an indication of the LTM configuration associated with the second network entity, the LTM configuration comprising the second set of configurations associated with the second cell.

20. A method for wireless communications by a user equipment, comprising:
obtaining, from a first network entity, at least one configuration for lower layer triggered mobility (LTM) among a plurality of cells served among at least the first network entity and a second network entity, wherein the at least one configuration includes a first set of configurations associated with a first cell and a second set of configurations associated with a second cell, wherein the plurality of cells includes the first cell and the second cell;
obtaining a first indication that the first set of configurations is associated with the first network entity and that the second set of configurations is associated with the second network entity; and
communicating with one or more of the first network entity or the second network entity via one or more of the first cell or the second cell based at least in part on one or more of the first set of configurations or the second set of configurations.
